(19) United States
(12) Patent Application Publication
(10) Pub. No.: US 2018/0200683 A1
(43) Pub. Date: Jul. 19, 2018

(54) SPIRAL MIXING CHAMBER WITH VORTEX GENERATING OBSTRUCTIONS

(71) Applicant: Xylem IP Holdings LLC, Wilmington, DE (US)

(72) Inventor: Jeffrey D. LOPES, Palatine, IL (US)

(21) Appl. No.: 15/843,835

(22) Filed: Dec. 15, 2017

Related U.S. Application Data
(60) Provisional application No. 62/434,683, filed on Dec. 15, 2016.

(51) Int. Cl. B01F 5/00; B01F 3/04; A23L 2/54; C02F 1/78

(52) U.S. Cl. CPC B01F 5/0065; A23V 2002/00; A23L 2/54; C02F 1/78; B01F 3/04787; B01F 2003/049; B01F 2003/04879; B01F 2003/04921; B01F 2003/04886; B01F 2215/0022; B01F 2215/0052; B01F 2005/0034; B01F 2005/0017; B01F 2005/0025; B01F 2215/0422; B01F 3/04468

(57) ABSTRACT

A spiral mixing chamber for dissolving a gas into a liquid, features a new and unique combination of a cap and a mixing plate. The cap may include a gas injector configured to receive gas. The mixing plate may include: a liquid inlet configured to receive liquid, a mixture outlet configured to provide a mixture of the gas and liquid from the spiral mixing chamber, and a flow path configured as a spiral geometry having a spiral that winds in a continuous and gradual curve around a central point from the liquid inlet to the mixture outlet, the flow path having flow path obstructions configured to cause disturbances in the flow which generates turbulent vortices that work to break apart bubbles in the mixture flowing through the spiral mixing chamber or device.

### CROSS-REFERENCE TO RELATED APPLICATIONS

This application claims benefit to provisional patent application Ser. No. 62/434,683 (911-029.1-2/X-ATI-0002US), filed 15 Dec. 2016, which is incorporated by reference in its entirety.

### BACKGROUND OF THE INVENTION

### 1. Field of Invention

This invention relates to a technique for mixing a gas and a liquid.

### 2. Description of Related Art

Typically devices that dissolve gases into fluids do so by means of a pressure tank and a compressor. The gas and liquid are held in a tank at a high pressure for a length of time sufficient to saturate the dissolution of the gas into the liquid. These devices require expensive components, generally consume a large amount of power, are large, have many components, and are typically loud.

### SUMMARY OF THE INVENTION

In summary, the present invention is a passive device whose purpose is to mix gases into a liquid by taking advantage of turbulent mixing instead of time and power. The device is a spiral mixing chamber that includes obstructions in the flow path that create eddies of the appropriate length scale to efficiently break up gas bubbles suspended in the fluid. This efficient break up and mixing of the liquid and gas is augmented by the secondary flow created by the curvature of the spiral. The dimensions of the flow path and of the obstructions can change throughout the device in order to cause the creation of a wide range of turbulent eddy length scales and ensure that bubbles of many sizes are broken down and mixed into the fluid.

### Specific Embodiments

According to some embodiments, the present invention may include, or take the form of, a spiral mixing chamber for dissolving a gas into a liquid, featuring a new and unique combination of a cap and a mixing plate.

The cap may include a gas injector configured to receive gas.

The mixing plate may include:
a liquid inlet configured to receive liquid,
a mixture outlet configured to provide a mixture of the gas and liquid from the spiral mixing chamber, and
a flow path configured as a spiral geometry having a spiral that winds in a continuous and gradual curve around a central point from the liquid inlet to the mixture outlet, the flow path having flow path obstructions configured to cause disturbances in the flow which generates turbulent vortices that work to break apart bubbles in the mixture flowing through the spiral mixing chamber or device.

The present invention may include one or more of the following features:

### The Flow Path Obstructions

The dimensions of the flow path and of the flow path obstructions can change throughout the flow path, e.g., in order to cause the creation of a wide range of turbulent eddy length scales and ensure that bubbles of many sizes are broken down and mixed into the fluid.

The flow path obstructions may include cylindrical flow path obstructions having different diameters that are configured or placed in the flow path in order to mix a range of bubble diameters, although the scope of the invention is not intended to be limited to any particular geometric shape, e.g., including a triangular shape, oval shape, square shape, etc. As the flow path winds away from the central gas and liquid receiving area or chamber, the flow path obstructions may change in size, shape or dimension, e.g., including alternately increasing and/or decreasing in size, dimension or diameter. By way of example, as the flow path winds away from the central gas and liquid receiving area or chamber to the mixture outlet, the flow path obstructions may include a repeating series of four flow path obstructions that decrease in size, dimension or diameter.

### The Spiral

According to some embodiments, the spiral geometry may be configured to create a main flow that has a component tangential to the spiral and a secondary flow which is in a direction perpendicular to the spiral geometry, including where the secondary flow enhances the mixing of the gas and the liquid relative to, or when compared to, a straight flow pathway.

According to some embodiments, the spiral may be defined by the equation:

r=a+bθ^{c},

where r and θ are polar coordinates based on a coordinate system whose origin O lies at the center of the spiral (see FIG. 5); and

where the constants a, b, and c define the geometry of the spiral, including where the parameter a determines the starting distance of the radius of the spiral from the origin O, the parameter b determines the tightness or turn of the spiral, and the parameter c determines the rate of change of the curvature of the spiral, also known as the distance between successive turns.

According to some embodiments, the spiral may take the form or an Archimedean spiral, or a logarithmic spiral, e.g., including where the width of the flow path stays the same or changes as the flow path winds away from the central gas and liquid receiving area or chamber to the mixture outlet.

According to some embodiments, the flow path obstructions may be configured in the flow path at a series of polar coordinates defined along one or more rays extending from a central chamber to an outer periphery of the spiral or flow path. The one or more rays may extend from the central chamber of the spiral may include eight arrays, each array having at least four flow path obstructions, including where at least four flow path obstructions have the same size, dimension or diameter. The eight arrays may be configured and spaced at polar coordinate angles that include 0°, 45°, 90°, 135°, 180°, 225°, 270°, 315° extending from the central chamber of the spiral, including where each array has at least four flow path obstructions with the same size, dimension or diameter. By way of example, the eight arrays may include first arrays at the polar coordinate angles of 0° and 180° having a first size, dimension or diameter; second arrays at the polar coordinate angles of 45° and 225° having a second size, dimension or diameter; third arrays at the polar coordinate angles of 90° and 270° having a third size, dimension or diameter; and fourth arrays at the polar coordinate angles of 135° and 315° having a fourth size, dimension or diameter, all consistent with that disclosed herein. Moreover, embodiments are envisioned, and the scope of the invention is intended to include, implementing flow path obstructions along the flow path having the same size, dimension or diameter; having the same or different geometric shapes, etc.

### The Flow Path

According to some embodiments, the flow path has a cross sectional area; and the cross sectional area of the flow-path may change along the length of the spiral, e.g. which changes the average fluid velocity and results in a changing Reynold's number along the flow path.

According to some embodiments, the flow path may include the central gas and liquid receiving chamber at the beginning of the flow path; the cap may include a central inner portion; and the gas injector may be configured at the central inner portion to provide the gas into the central gas and liquid receiving chamber.

According to some embodiments, the flow path may include the central gas and liquid receiving chamber at the beginning of the flow path; the mixing plate may include a corresponding central inner portion; and the liquid inlet may be configured at the corresponding central inner portion to provide the liquid into the central gas and liquid receiving chamber.

According to some embodiments, the flow path may include a flow path provisioning chamber at the end of the flow path; the mixing plate may include a corresponding central inner portion and an outer peripheral portion; the liquid inlet may be configured at the corresponding central inner portion to provide the liquid into the central gas and liquid receiving chamber; and the mixture outlet may be configured at the outer peripheral portion to provide the mixture of the gas and liquid from the spiral mixing chamber.

According to some embodiments, the flow path may include the central gas and liquid receiving chamber at the beginning of the flow path; the gas injector may be configured to receive and provide a forced gas into the central gas and liquid receiving chamber; the liquid inlet may be configured to receive and provide a forced liquid into the central gas and liquid receiving chamber; and the forced gas and the forced liquid may be provided into the central gas and liquid receiving chamber at a pre-defined ratio.

### The Gas Injector and Other Components

According to some embodiments, the gas injector may include, or take the form of, a carb-stone which is a porous device that forces the gas through and produces very small bubbles. Alternatively, the gas injector may include, or take the form of, a sintered steel cylinder that includes holes configured or formed therein that allow for the assumption of a distributed gas mass flow rate.

According to some embodiments, the spiral mixing chamber may include a gasket arranged between the cap and the mixing plate configured to seal the flow path.

According to some embodiments, the spiral mixing chamber may include an inner O-ring arranged between an inner surface of the cap and a rim-like portion of the gas injector configured to provide an inner seal between the cap and the gas injector.

According to some embodiments, the cap may include a gap injector opening configured or formed therein to receive at least part of the gas injector.

According to some embodiments, the spiral mixing chamber may include an outer O-ring arranged between a peripheral rim of the mixing plate and a corresponding peripheral rim of the cap and configured to provide an outer seal between the mixing plate and the cap.

### The Method

According to some embodiments, the present invention may include a method for dissolving a gas into a liquid using a mixing chamber, featuring:

configuring a cap with a gas injector to receive gas; and

configuring a mixing plate having
a liquid inlet to receive liquid,
a mixture outlet to provide a mixture of the gas and liquid from the spiral mixing chamber, and
a flow path with a spiral geometry having a spiral that winds in a continuous and gradual curve around a central point from the liquid inlet to the mixture outlet, the flow path having flow path obstructions configured to cause disturbances in the flow which generates turbulent vortices that work to break apart bubbles in the mixture flowing through the spiral mixing chamber or device.

The method may include one or more of the other features set forth herein.

### BRIEF DESCRIPTION OF THE DRAWING

The drawing, which are not necessarily drawn to scale, includes FIGS. 1-7, as follows:

FIG. 1 is an exploded view of a spiral mixing chamber, according to some embodiments of the present invention.

FIG. 2 is a top perspective assembled view of the spiral mixing chamber shown in FIG. 1, according to some embodiments of the present invention.

FIG. 3 is a bottom perspective assembled view of the spiral mixing chamber shown in FIG. 1, according to some embodiments of the present invention.

FIG. 4 is a top perspective or isometric view of a mixing plate that forms part of the spiral mixing chamber shown in FIG. 1, according to some embodiments of the present invention.

FIG. 5 is a front or top plan view of the mixing plate that forms part of the spiral mixing chamber shown in FIG. 4, according to some embodiments of the present invention.

FIG. 6 is a diagram of a gas inlet device that forms part of the spiral mixing chamber, according to some embodiments of the present invention.

FIG. 7 is a cross-sectional assembled view of the spiral mixing chamber shown in FIG. 2 cutting across the gas inlet device, according to some embodiments of the present invention.

FIG. 8 shows r and theta used in the definition/Equation of the spiral shape.

FIG. 9 includes FIGS. 9A thru 9G, and illustrates the effects of changing each of the parameters on the base spiral shown in FIG. 9A (Note that the overall size of the spirals have been normalized in the figure, but changes in the parameters a, b, and c would also result in significant changes to the overall size of the spiral.).

To reduce clutter in the drawing, each Figure in the drawing does not necessarily include every reference label for every element shown therein.

### DETAILED DESCRIPTION OF BEST MODE OF THE INVENTION

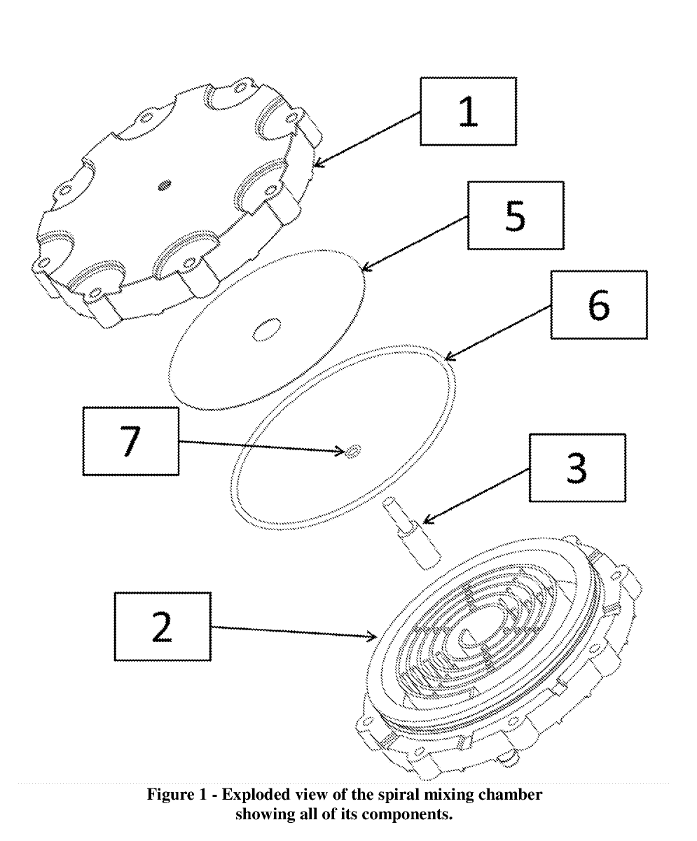

FIG. 1 shows an exploded view of a spiral mixing chamber or device generally indicated as 10, which includes all of the basic components in the device. The main physical components are a cap (1), a mixing plate (2), and a gas injector (3). FIG. 1 also shows a gasket (5), an outer O-ring (6), and an inner O-ring (7); these components are for sealing the spiral mixing chamber or device (10), and are necessary for the function of the present invention as it is disclosed and embodied herein, but may not be required for other embodiments of the present invention within the spirit of that disclosed herein. Gaskets and O-rings are known in the art, and the scope of the invention is not intended to be limited to any particular type or kind thereof. Embodiments are also envisioned, and the scope of the invention is intended to include, implementations where the gasket and O-ring(s) are not separate components, e.g., including where the gasket forms an integral part of the cap (1) or mixing plate (2), and also including using an additive manufacturing process.

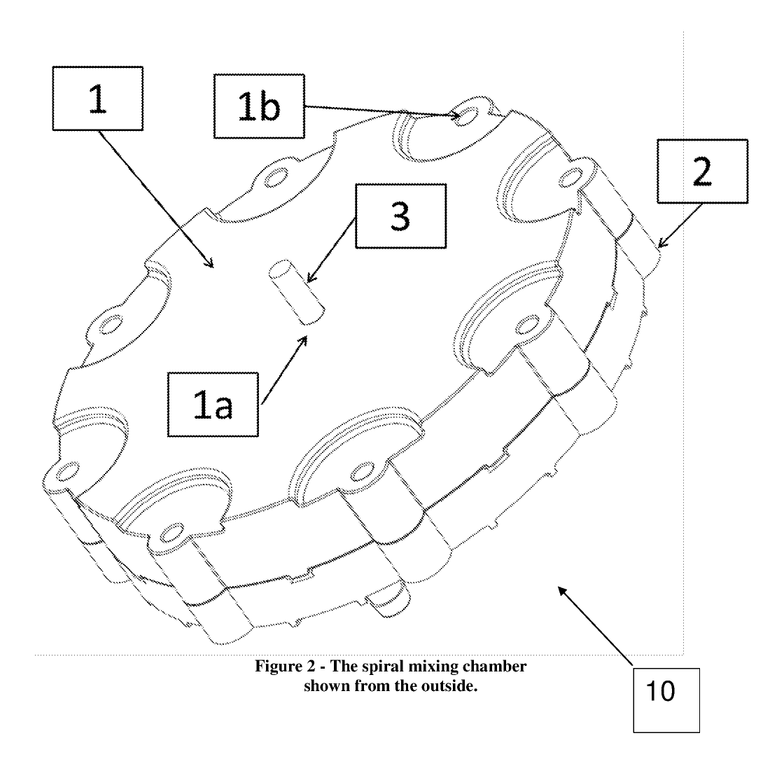

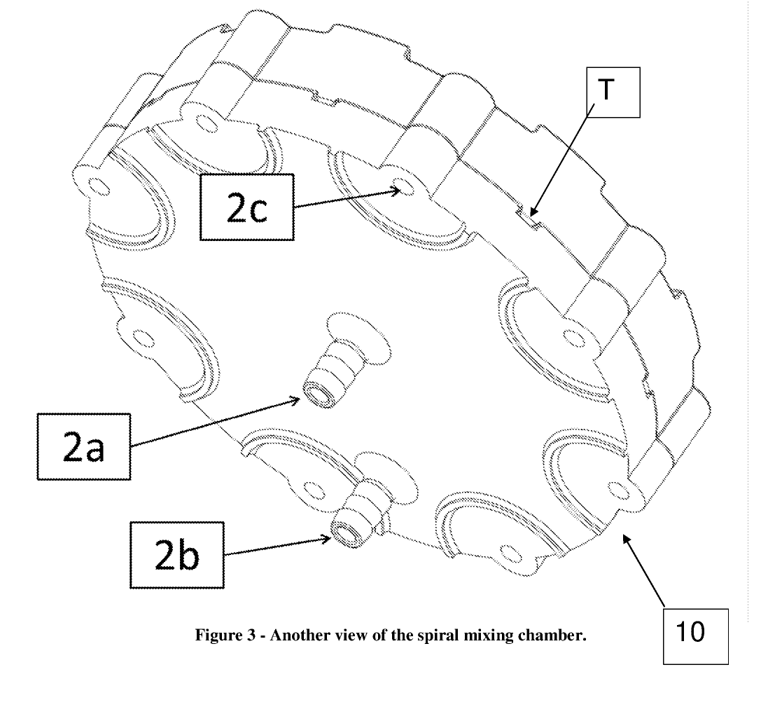

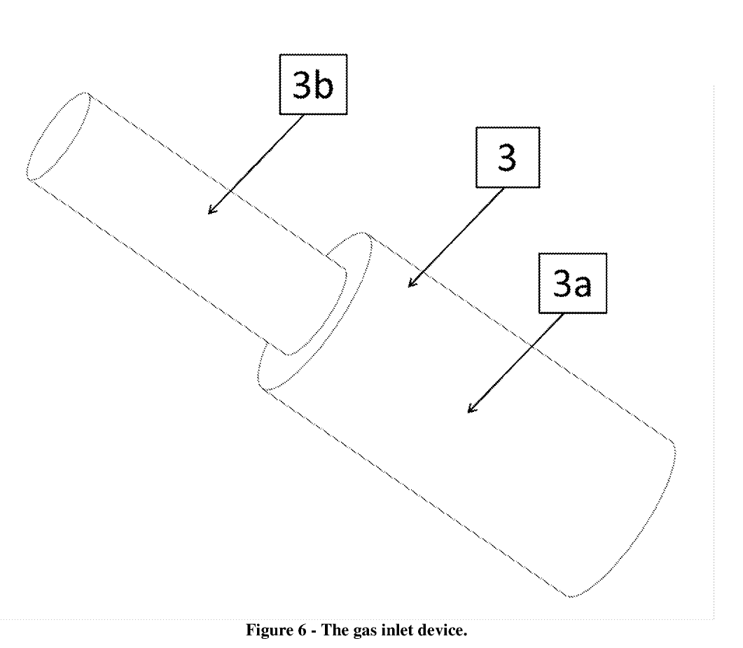

FIG. 2 shows the spiral mixing chamber (10) according to some embodiments of the present invention assembled together. The cap (1) and the mixing plate (2) may be connected using nuts and bolts (not shown) that go through cap holes (1b) and mixing plate holes (2c (FIG. 3)). The gas injector (3) may be positioned through a cap gas inlet (1a) such that its inlet extends beyond the cap (1), e.g., to allow for a hose or similar device (not shown) to connect to it and provide the gas which is to be mixed to the inside of the spiral mixing chamber (10) according to the present invention. See and compare that shown in FIG. 6, which shows the gas injector (3) in further detail.

FIG. 3 shows the assembled spiral mixing chamber (10) from behind the mixing plate (2). FIG. 3 shows a liquid inlet (2a) and a mixture outlet (2b), e.g., extending from the mixing plate (2).

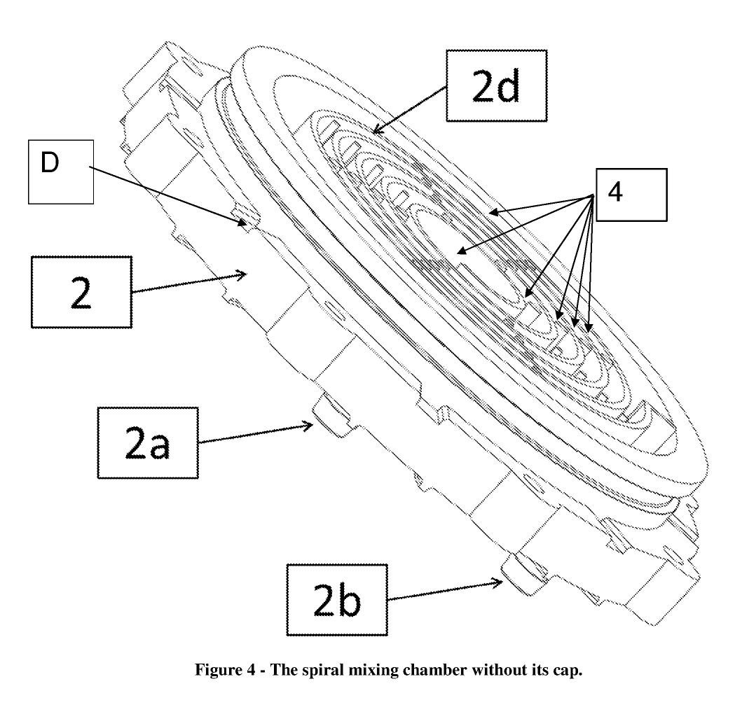

FIG. 4 shows the mixing plate (2) and its spiral geometry generally indicated as (2d) having a spiral or spiral wall S that is used to define a flow path (4) of the mixture of the gas and liquid.

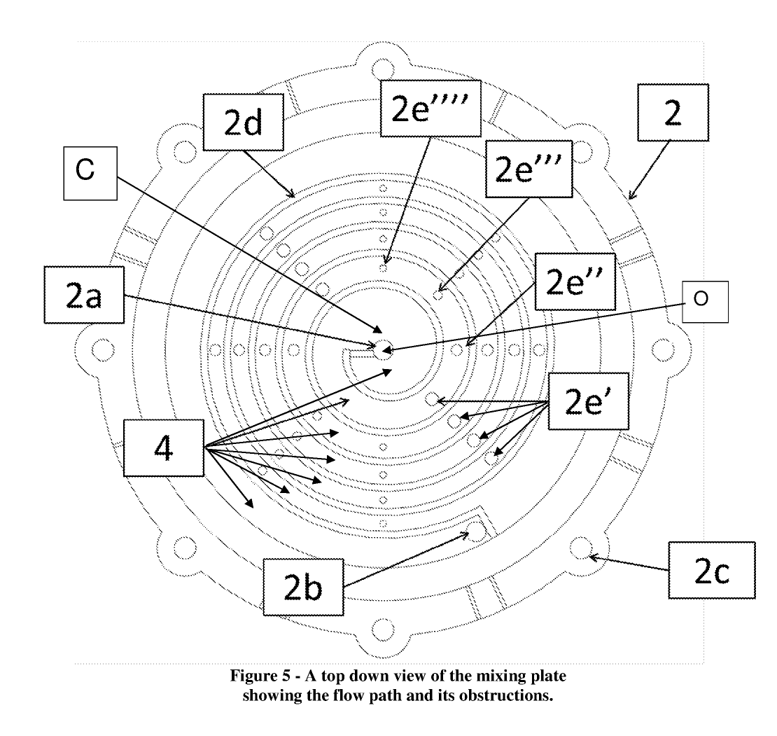

FIG. 5 shows the mixing plate (2) and the flow path (4). The mixing plate (2) also include flow path obstructions (2e′), (2e″), (2e″′) and (2e″″). In FIGS. 4 and 5, a series of flow path arrows show the spiral curvature of the flow path (4) as it winds from a central gas/liquid receiving area or chamber generally indicated as C, e.g., where the gas is provided by the gas injector (3 (FIG. 2)) and the liquid is provided by the liquid inlet (2a (FIG. 3)), to the mixture outlet (2b), e.g., where the mixture of gas and liquid is provided from the spiral mixing chamber (10) for further processing. In FIG. 5, the mixture outlet (2b) is arranged at the an outer peripheral portion (P) of the mixing plate (2) and at the end of the flow path (4).

FIG. 6 shows the gas injector (3), e.g., which may be composed of an inlet pipe (3a) and an outlet (3b). By way of example, and according to some embodiments of the present invention, the outlet (3b) in FIG. 6 may be described as, or take the form of, a sintered steel cylinder which has many holes in it, e.g., that allow for the assumption of a completely distributed gas mass flow rate along the outside of that part of the gas injector (3).

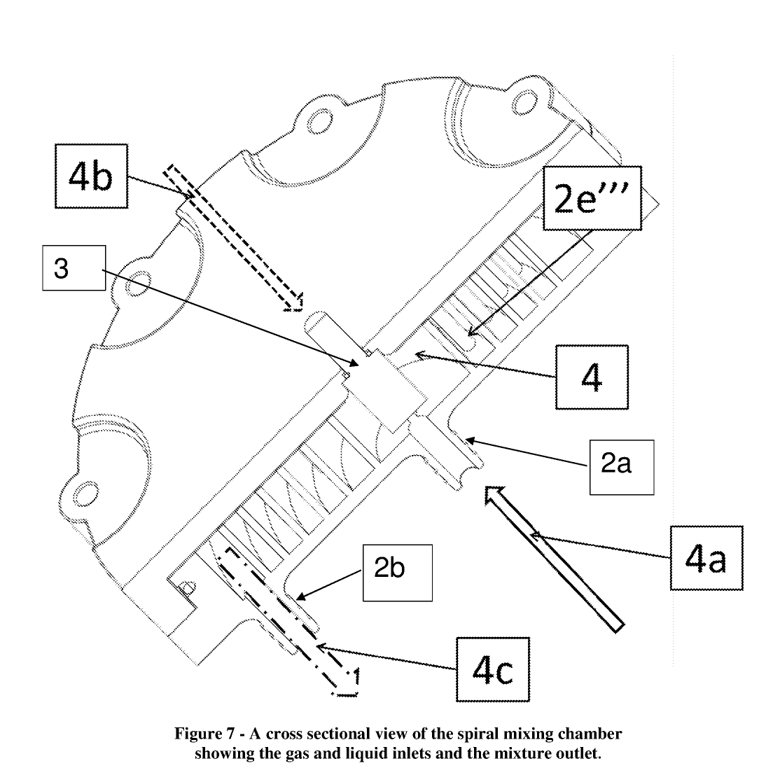

FIG. 7 shows the cross sectional view of the spiral mixing chamber assembly (10) and identifies components of the flow path (4), e.g., that may include the liquid inlet (2a) whose direction and flow is designated by the solid lined arrow (4a) shown in FIG. 7; the gas injector or inlet (3) whose direction and flow is shown using the dashed arrow (4b) in FIG. 7; and a mixture outlet (2b) whose direction and flow is indicated by the dash-dot arrow (4c) shown in FIG. 7.

The purpose of the spiral mixing chamber or device (10) is to dissolve the gas into the liquid into a predetermined concentration as quickly and efficiently as possible. To achieve this dissolution, the liquid and the gas may be forced under pressure into the spiral mixing chamber (10), e.g., at a pre-defined ratio through the liquid inlet (2a) and the gas inlet (3) respectively. The mixture is then guided by the spiral geometry from the central gas and liquid receiving area or chamber (C (FIG. 5)) to the mixture outlet (4c) shown in FIG. 7. See also FIGS. 3-5. As one skilled in the art would appreciate, the spiral geometry creates a main flow that has a component tangential to the spiral and a secondary flow which is in a direction perpendicular to the spiral geometry. This secondary flow enhances the mixing of the gas and the liquid, e.g., relative, or in comparison, to a straight flow pathway, especially at lower Reynolds numbers. The flow path (4) also has the flow path obstructions (2e′), (2e″), (2e″′) and (2e″″), e.g., that cause disturbances in the flow which generate turbulent vortices. These turbulent vortices work to break apart any bubbles in the mixture flowing past each flow path obstruction (2e′), (2e″), (2e″′) and (2e″″).

Generally, it is understood that bubbles suspended in a flow path like element (4) may be broken up most efficiently by turbulent vortices, e.g., whose length scale is about the same as the average diameter of the bubble. In effect, the flow past a flow path obstruction, e.g., shaped as a cylinder, results in a turbulent wake, and the length scale of the vortices produced can be predicted reasonably accurately by knowing the Reynolds number of the flow going past the cylinder as well as the diameter of the cylinder. According to some embodiments of the present invention, several cylindrical flow path obstructions (e.g., like elements (2e′), (2e″), (2e″′) and (2e″″)) of different diameters may be placed in the flow path (4) in order to efficiently mix a wide range of bubble diameters. For example, see FIG. 5 and compare the flow path obstruction cylinders (2e′, 2e″, (2e″′, 2e″″), e.g., where the flow path obstruction cylinders (2e′) have a first diameter, where the flow path obstruction cylinders (2e″) have a second and smaller diameter than the flow path obstruction cylinders (2e′), where the flow path obstruction cylinders (2e′″) have a third and smaller diameter than the flow path obstruction cylinders (2e″), and where the flow path obstruction cylinders (2e″) have a fourth diameter and smaller diameter than the flow path obstruction cylinders (2e′″). In FIG. 5, as the flow path (4) winds from the central gas and liquid receiving chamber C to the mixture outlet 2b, the diameter or size of the flow path obstruction cylinders (2e′, 2e″, 2e″′, 2e″″) changes. By way of example, and consistent with that shown in FIG. 5, the flow path (4) starts with a large diameter flow path obstruction cylinder like element (2e′) and changes to smaller and smaller diameter flow path obstruction cylinder like element (2e″, 2e′″, 2e″). As the flow path (4) continues to wind from the central gas and liquid receiving chamber (C) to the mixture outlet (2b), and after the initial four flow path obstruction cylinders, the diameter or size of the flow path obstruction cylinders (2e′, 2e″, 2e″′, 2e″″) changes back to the large diameter flow path obstruction cylinder like element (2e′) and repeats the pattern of smaller and smaller diameter flow path obstruction cylinders like elements (2e″, 2e″′, 2e″″). As the flow path (4) continues to wind from the central gas and liquid receiving chamber (C) to the mixture outlet (2b), this pattern of larger to smaller flow path obstruction cylinders repeats itself. In addition to this, the cross sectional area of the flow-path may change along the length of the spiral, e.g., which changes the average fluid velocity and results in a changing Reynold's number along the flow path.

By way of example, and consistent with that disclosed herein, the spiral can be described using the equation:

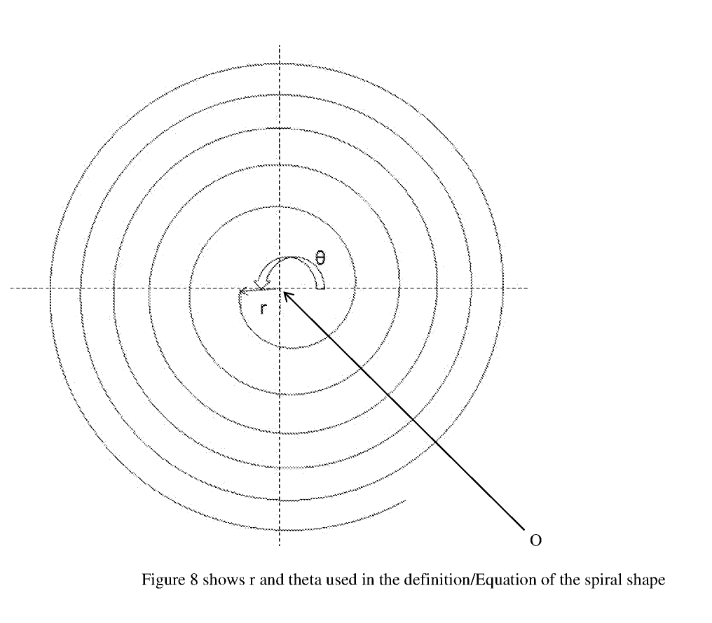

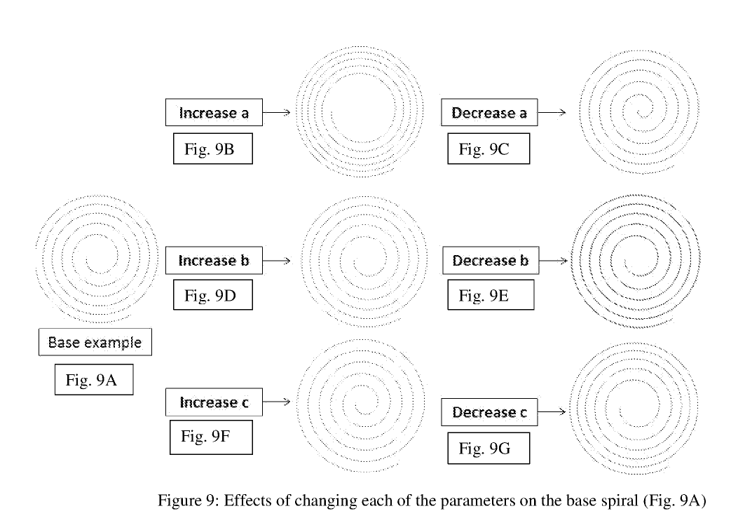

r=a+bθ^{c},

where r and θ are polar coordinates based on a coordinate system whose origin lies at the center of the spiral; and

where the constants a, b, and c define the geometry of the spiral, including where the parameter a determines the starting distance of the radius of the spiral from the origin O, the parameter b determines the tightness or turn of the spiral, and the parameter c determines the rate of change of the curvature of the spiral, also known as the distance between successive turns. See FIGS. 8-9 re how changes in the parameters a, b and c effect the spiral geometry.

When put into contact with each other, the gas will dissolve into the liquid until it reaches an equilibrium state. The rate at which the gas will dissolve into the liquid is determined by the concentration of the gas in the liquid and the surface area of contact between the two at the current time, the higher the concentration the slower the dissolution.

According to some embodiments, the gas injector (3) may take the form of a commonly known device, e.g., such as a carb-stone which is a porous device that forces gas through from its inlet to its outlet and produces very small bubbles. This technique alone produces a high surface area of contact between the gas and the liquid which enhances the rate of dissolution. The enhanced mixing causes the bubbles to come in contact with fresh liquid again speeding up the dissolution. The flow path obstructions (2e′, 2e″, 2e′″, 2e″″) act to break up the bubbles into even smaller bubbles which further increases the surface area of contact which results in an even higher rate of mixing.

According to some embodiments, the spiral mixing chamber or device can be optimized for specific gases, liquids, flow rates, pressures, and concentrations by changing the spiral geometry and obstruction geometry.

### The Detents and Tabs

According to some embodiments, the cap (1) may include a peripheral rim having tabs (T) configured or formed therein; and the mixing plate (2) may include corresponding peripheral rim having detents (D) configured or formed therein to receive the tabs (T) for coupling the cap (1) and mixing plate (2) together for preventing rotation.

### Techniques for Pressurizing Gases and Liquids

Techniques for pressurizing gases and liquids are known in the art, and the scope of the invention is not intended to be limited to any particular type or kind thereof, e.g., either now known or later developed in the future. For example, pumps may be configured to provide gases and liquids under pressure.

### Possible Applications

Possible applications include the following:

Carbonation of beverages,

Nitrogenator of beverages, or

Oxygenation of liquids.

Applications also include the addition of Ozone to water for sanitation purposes.

### The Scope of the Invention

While the invention has been described with reference to an exemplary embodiment, it will be understood by those skilled in the art that various changes may be made and equivalents may be substituted for elements thereof without departing from the scope of the invention. In addition, may modifications may be made to adapt a particular situation or material to the teachings of the invention without departing from the essential scope thereof. Therefore, it is intended that the invention not be limited to the particular embodiment(s) disclosed herein as the best mode contemplated for carrying out this invention.

What is claimed is:

1. A spiral mixing chamber for dissolving a gas into a liquid, comprising:
a cap having a gas injector configured to receive gas; and
a mixing plate having a liquid inlet configured to receive liquid, having a mixture outlet configured to provide a mixture of the gas and liquid from the spiral mixing chamber, and having a flow path configured as a spiral geometry having a spiral that winds in a continuous and gradual curve around a central point from the liquid inlet to the mixture outlet, the flow path having flow path obstructions configured to cause disturbances in the flow which generates turbulent vortices that work to break apart bubbles in the mixture flowing through the spiral mixing chamber or device.

2. A spiral mixing chamber according to claim 1, wherein the dimensions of the flow path and of the flow path obstructions can change throughout the flow path, in order to cause the creation of a wide range of turbulent eddy length scales and ensure that bubbles of many sizes are broken down and mixed into the fluid.

3. A spiral mixing chamber according to claim 1, wherein the spiral is defined by the equation:
r=a+bθ^{c},
where r and θ are polar coordinates based on a coordinate system whose origin O lies at the center of the spiral; and
where the constants a, b, and c define the geometry of the spiral, including where the parameter a determines the starting distance of the radius of the spiral from the origin O, the parameter b determines the tightness or turn of the spiral, and the parameter c determines the rate of change of the curvature of the spiral.

4. A spiral mixing chamber according to claim 1, wherein the spiral is an Archimedean spiral or a logarithmic spiral.

5. A spiral mixing chamber according to claim 1, wherein the flow path obstructions are configured in the flow path at a series of polar coordinates defined along one or more rays extending from a central chamber to an outer periphery of the spiral or flow path.

6. A spiral mixing chamber according to claim 5, wherein the one or more rays extend from the central chamber of the spiral include eight arrays, each array having at least four flow path obstructions, including where each array has the at least four flow path obstructions with the same size, dimension or diameter.

7. A spiral mixing chamber according to claim 6, wherein the eight arrays are configured and spaced at polar coordinate angles that include 0°, 45°, 90°, 135°, 180°, 225°, 270°, 315° extending from the central chamber of the spiral, including where the eight arrays include first arrays at the polar coordinate angles of 0° and 180° having a first size, dimension or diameter; second arrays at the polar coordinate angles of 45° and 225° having a second size, dimension or diameter; third arrays at the polar coordinate angles of 90° and 270° having a third size, dimension or diameter; and fourth arrays at the polar coordinate angles of 135° and 315° having a fourth size, dimension or diameter.

8. A spiral mixing chamber according to claim 1, wherein the flow path obstructions comprise cylindrical flow path obstructions having different diameters that are configured or placed in the flow path in order to mix a range of bubble diameters.

9. A spiral mixing chamber according to claim 1, wherein
the flow path has a cross sectional area; and
the cross sectional area of the flow-path changes along the length of the spiral which changes the average fluid velocity and results in a changing Reynold's number along the flow path.

10. A spiral mixing chamber according to claim 1, wherein the gas injector is a carb-stone which is a porous device that forces the gas through and produces very small bubbles.

11. A spiral mixing chamber according to claim 1, wherein the gas injector is a sintered steel cylinder that includes holes configured or formed therein that allow for the assumption of a distributed gas mass flow rate.

12. A spiral mixing chamber according to claim 1, wherein the spiral mixing chamber comprises a gasket arranged between the cap and the mixing plate configured to seal the flow path.

13. A spiral mixing chamber according to claim 1, wherein the spiral mixing chamber comprises an inner O-ring arranged between an inner surface of the cap and a rim-like portion of the gas injector configured to provide an inner seal between the cap and the gas injector.

14. A spiral mixing chamber according to claim 13, wherein the cap includes a gap injector opening configured or formed therein to receive at least part of the gas injector.

15. A spiral mixing chamber according to claim 1, wherein the spiral mixing chamber comprises an outer O-ring arranged between a peripheral rim of the mixing plate and a corresponding peripheral rim of the cap and configured to provide an outer seal between the mixing plate and the cap.

16. A spiral mixing chamber according to claim 1, wherein the spiral geometry is configured to create a main flow that has a component tangential to the spiral and a secondary flow which is in a direction perpendicular to the spiral geometry, including where the secondary flow enhances the mixing of the gas and the liquid relative to, or when compared to, a straight flow pathway.

17. A spiral mixing chamber according to claim 1, wherein
the flow path includes a central gas and liquid receiving chamber at the beginning of the flow path;
the cap includes a central inner portion;
the gas injector is configured at the central inner portion to provide the gas into the central gas and liquid receiving chamber.

18. A spiral mixing chamber according to claim 1, wherein
the flow path includes a central gas and liquid receiving chamber at the beginning of the flow path;
the mixing plate includes a corresponding central inner portion; and
the liquid inlet is configured at the corresponding central inner portion to provide the liquid into the central gas and liquid receiving chamber.

19. A spiral mixing chamber according to claim 1, wherein
the flow path includes a flow path provisioning chamber at the end of the flow path;
the mixing plate includes a corresponding central inner portion and an outer peripheral portion;
the liquid inlet is configured at the corresponding central inner portion to provide the liquid into the central gas and liquid receiving chamber; and
the mixture outlet is configured at the outer peripheral portion to provide the mixture of the gas and liquid from the spiral mixing chamber.

20. A spiral mixing chamber according to claim 1, wherein the cap includes cap holes configured or formed therein to receive fasteners/bolts; and
the mixing plate includes corresponding mixing plate holes configured or formed therein to receive the fasteners/bolts for coupling the cap and mixing plate together.

21. A spiral mixing chamber according to claim 1, wherein
the cap includes a peripheral rim having tabs configured or formed therein; and
the mixing plate includes corresponding peripheral rim having detents configured or formed therein to receive the tabs for coupling the cap and mixing plate together and preventing rotation.

22. A spiral mixing chamber according to claim 1, wherein
the flow path includes a central gas and liquid receiving chamber at the beginning of the flow path;
the gas injector is configured to receive and provide a forced gas into the central gas and liquid receiving chamber;
the liquid inlet is configured to receive and provide a forced liquid into the central gas and liquid receiving chamber; and
the forced gas and the forced liquid are provided into the central gas and liquid receiving chamber at a pre-defined ratio.

23. A method for dissolving a gas into a liquid using a mixing chamber, comprising:
configuring a cap with a gas injector to receive gas; and
configuring a mixing plate having
a liquid inlet to receive liquid,
a mixture outlet to provide a mixture of the gas and liquid from the spiral mixing chamber, and
a flow path with a spiral geometry having a spiral that winds in a continuous and gradual curve around a central point from the liquid inlet to the mixture outlet, the flow path having flow path obstructions configured to cause disturbances in the flow which generates turbulent vortices that work to break apart bubbles in the mixture flowing through the spiral mixing chamber or device.
